(19) United States
(12) Patent Application Publication
(10) Pub. No.: US 2010/0208385 A1
(43) Pub. Date: Aug. 19, 2010

(54) STORAGE DEVICE WITH READ-AHEAD FUNCTION

(75) Inventor: Norikatsu Toukairin, Hachioji-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/705,519

(22) Filed: Feb. 12, 2010

(30) Foreign Application Priority Data
Feb. 13, 2009 (JP) 2009-030981

(51) Int. Cl. G11B 21/02

(52) U.S. Cl. 360/75; G9B/21.003

(57) ABSTRACT

According to one embodiment, a storage device includes a link information creation module and a read-ahead process module. The link information creation module creates link information for associating storage regions on a storage medium, which store a plurality of data included in a single file, in an order according to continuity of the plurality of data. The read-ahead process module performs a read-ahead of data stored in a storage region on the basis of the link information, the storage region being associated with a storage region of the storage medium which is designated by the data read request.

### CROSS-REFERENCE TO RELATED APPLICATIONS

This application is based upon and claims the benefit of priority from Japanese Patent Application No. 2009-030981, filed Feb. 13, 2009, the entire contents of which are incorporated herein by reference.

### BACKGROUND

1. Field

One embodiment of the invention relates generally to a storage device, and more particularly to a data write and read technique which is applied to a storage device such as a hard disk drive (HDD).

2. Description of the Related Art

With the advancement of the information-oriented society in these years, the amount of data stored in a storage device such as an HDD has become enormous. Accordingly, there is a need for a further increase in the speed of data read from the storage device. As regards the increase in data read speed, there is known a cache memory technology. In addition, as a technique using a cache memory, there has been proposed a technique in which successive data are written in successive sectors (regions) on a storage medium such as a hard disk, and identification information which is common to the successive data is written in each sector (e.g. Jpn. Pat. Appln. KOKAI Publication No. 6-289999). In this technique, the successive data having the same identification information as the identification information of data, the read of which has been requested, can be read ahead into a buffer (cache).

However, in many cases, the conventional cache memory technique presupposes, or expects, that successive data are written in physically neighboring sectors.

On the other hand, the technique of KOKAI Publication No. 6-289999 is applicable to the case where successive data are randomly recorded at plural positions on the magnetic disk. In this case, however, since the identification information is recorded together with each data, the amount of data which can be stored in one sector decreases by an amount of the identification information. In this case, if the decrease in the data amount is to be compensated, it is necessary to adopt, for example, a special sector length to which a length corresponding to the data amount of the identification information is added. This may deteriorate the general-purpose applicability of the apparatus.

Therefore, it is necessary to realize a novel technique for increasing the data read speed without deteriorating the general-purpose applicability.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram which schematically shows the structure of a storage device according to an embodiment of the invention;

FIG. 2 is an exemplary view showing the data structure of a link information table which is used in the storage device of the embodiment;

FIG. 3 is an exemplary view showing the data structure of a file information table which is used in the storage device of the embodiment;

FIG. 4 is an exemplary block diagram showing the internal structure of a controller which is provided in the storage device of the embodiment;

FIG. 5 is an exemplary view showing successive data of a file;

FIG. 6 is an exemplary flow chart showing the procedure of a link information creation process which is executed by the storage device of the embodiment;

FIG. 7A is an exemplary flow chart showing the procedure of a read process which is executed by the storage device of the embodiment;

FIG. 7B is an exemplary flow chart showing the procedure of a read-ahead process which is executed by the storage device of the embodiment; and

FIG. 8 is an exemplary view showing a data structure relating to index information of read-ahead data which is stored in a buffer memory provided in the storage device of the embodiment.

### DETAILED DESCRIPTION

Various embodiments according to the invention will be described hereinafter with reference to the accompanying drawings. In general, according to one embodiment of the invention, there is provided a storage device comprising: a storage medium; a link information creation module configured to create link information for associating storage regions on the storage medium, which store a plurality of data included in a single file, in an order according to continuity of the plurality of data; and a read-ahead module configured to perform a read-ahead of data stored in a storage region based on the link information when a data read request is received from a host, the storage region being associated with a storage region on the storage medium which is designated by the data read request.

According to this embodiment, the link information is created for associating the storage regions on the storage medium, which store the plurality of data included in a single file, in an order according to the continuity of the plurality of data. When a data read request from a host is received, a read-ahead of data stored in a storage region is performed based on the link information, the storage region being associated with a storage region on the storage medium which is designated by the data read request. Thus, for example, it is possible to perform a read-ahead of the data, a read request of which is expected to be next output from the host. Thereby, the data read can be executed at high speed. In this case, since the read-ahead is executed on the basis of the link information which is created when data is recorded in the storage medium, the data read speed can be increased regardless of the data access method, without deteriorating the general-purpose applicability.

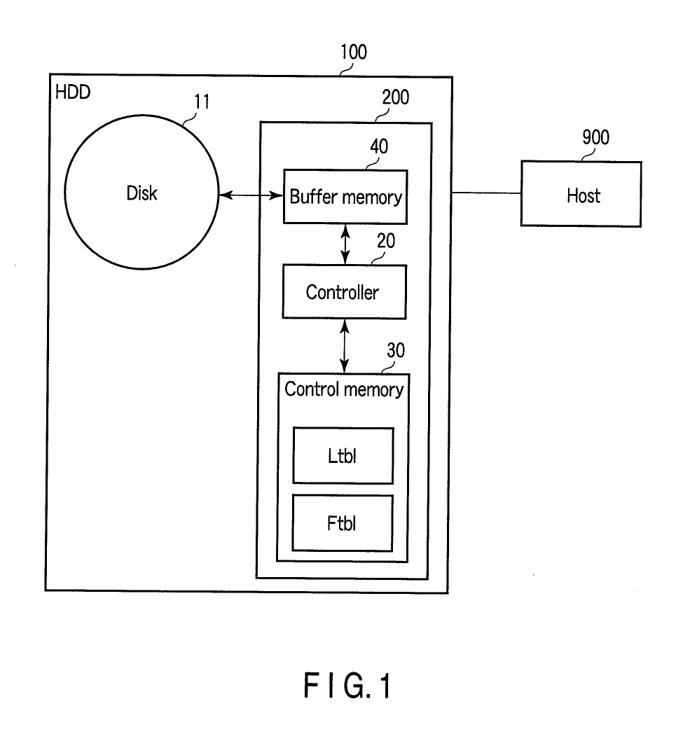

FIG. 1 schematically shows the structure of a hard disk drive (HDD) 100 functioning as a storage device according to the embodiment. The HDD 100 is an embedded type storage device which is built in a host 900 which is composed of, e.g. a personal computer (PC), or an external connection type storage device which is connected to the host 900 by a connector or the like. The HDD 100 executes data write and data read in accordance with a command (write command or read command) which is received from the host 900.

As shown in FIG. 1, the HDD 100 comprises a magnetic disk 11 serving as a storage medium, and a control device 200 which controls the operation of the magnetic disk 11 and the operation of, e.g. a read/write head for executing write and read of information on the magnetic disk 11. In the meantime, the HDD 100 performs write and read in a so-called random access method.

The control device 200 includes a controller 20 which is composed of, e.g. a CPU, a control memory 30 for storing information which is used for controlling the controller 20, and a buffer memory 40 which temporarily stores data at a time of data write (record) and data read (reproduction) on the magnetic disk 11.

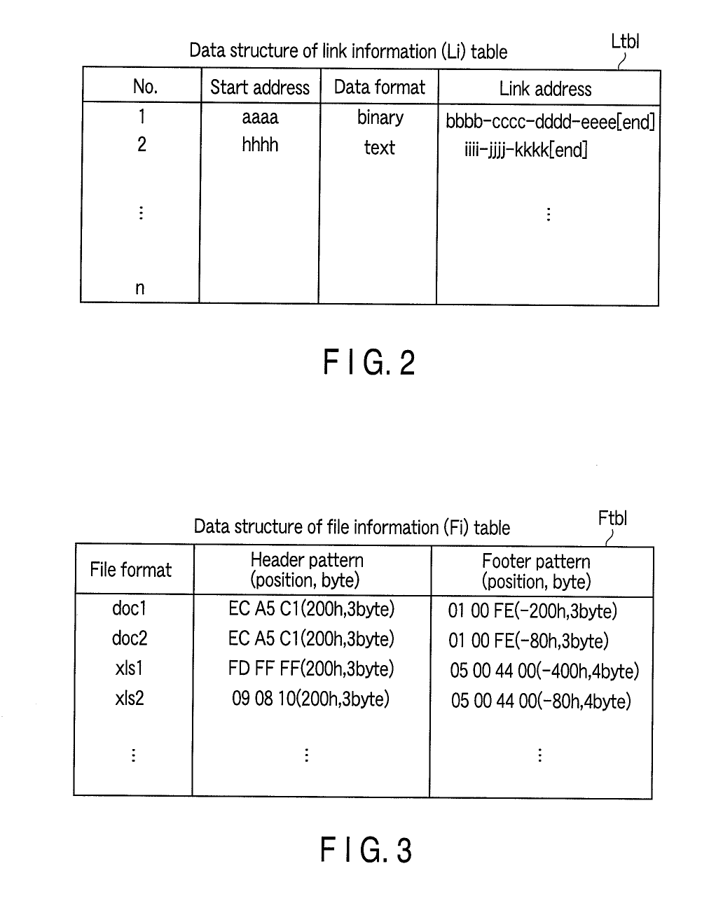

The control memory 30 stores, for example, a link information table (Ltbl) (see FIG. 2) and a file information table (Ftbl) (see FIG. 3), which are used by the controller 20 at the time of data write or data read.

As shown in FIG. 2, the link information table Ltbl includes a plurality of link information (Li) items (in FIG. 2, an n-number of link information items to which serial numbers 1 to n are allocated). The link information (Li) includes an address (start address) of a sector in which start data (e.g. Fd1 in FIG. 5) of a file is stored, a data format (e.g., binary data/text data) of the file, and a link address which successively indicates sectors (record sectors) in which file data constituting the file are stored. For example, the second link information in FIG. 2 means that plural file data (e.g. Fd1 to Fd4 in FIG. 5) constituting a file are successively stored in the order of addresses “hhhh”, “iiii”, “jjjj” and “kkkk” on the magnetic disk 11. In the link information table Ltbl, new link information (Li) is added each time a file (file data) is recorded in the HDD 100.

As shown in FIG. 3, the file information table Ftbl includes a plurality of file information (Fi) items. The file information (Fi) items are created in association with individual file formats of files which are created by various applications. As shown in FIG. 3, the file information Fi includes, for example, an ID indicative of a file format, a header byte pattern of start data of a file (including the position (offset) of the header from the file start position and the header byte number), and a footer byte pattern indicative of end data of the file (including the position (offset) of the footer from the file end position and the footer byte number). The file information table Ftbl is created prior to shipment of the HDD 100, and is stored in the control memory 30. However, the structure of the file information table Ftbl is not limited to this example, and the file information table Ftbl may be configured such that the content thereof can be updated by using, e.g. a management tool, even after the shipment of the HDD 100.

As the control memory 30 of the embodiment, use is made of a volatile memory is capable of executing data write and data read at a higher speed, compared to the magnetic disk 11. Thus, in the present embodiment, before the HDD 100 is powered off, it is necessary to temporarily store the data (link information table Ltbl and file information table Ftbl), which is stored in the control memory 30, into a predetermined storage region on the magnetic disk 11. On the other hand, when the HDD 100 is powered on (activated), the link information table Ltbl and file information table Ftbl, which are temporarily stored in the predetermined storage region on the magnetic disk 11, are transferred to the control memory 30.

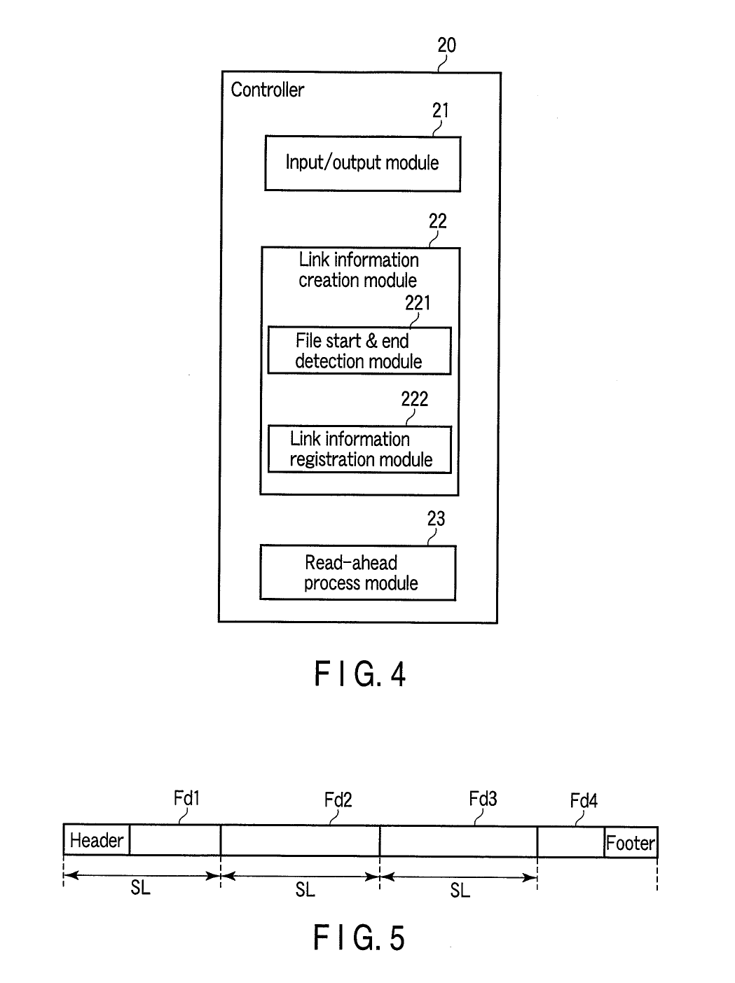

FIG. 4 shows a functional block diagram of the controller 20. As shown in FIG. 4, the controller 20 comprises an input/output module 21 which transfers data between the magnetic disk 11 and the host 900, a link information creation module 22 which creates (updates) the link information table Ltbl, and a read-ahead process module 23 which reads out data from the magnetic disk 11 on the basis of the link information Li of the link information table Ltbl.

In the case where the input/output module 21 has received a write command from the host 900, the input/output module 21 writes data, which has been sent from the host 900 together with the write command, in the magnetic disk 11 via the buffer memory 40 (write process). In the case where the input/output module 21 has received a read command from the host 900, the input/output module 21 transfers data, which is stored in a sector designated by the read command, to the host 900 (read process). The details of the write process, the read process and processes associated with these processes will be described later.

As shown in FIG. 4, the link information creation module 22 includes a file start & end detection module 221 and a link information registration module 222. The file start & end detection module 221 specifies the start data of a file and the end data of the file by detecting the header and footer of the file that is to be stored. The link information registration module 222 registers the link information Li in the link information table Ltbl by making use of a detection result (specified result) of the file start & end detection module 221.

The read-ahead process module 23 specifies a read command which is expected to be output from the host 900 (the data, a read request for which is expected to be issued from the host 900) on the basis of the link information of the link information table Ltbl, and performs a read-ahead of this data (i.e. pre-reads or pre-fetches the data), thus storing the data in the buffer memory 40.

The file data that is stored in the HDD 100 is described in brief with reference to FIG. 5. In the HDD 100 of the embodiment, the data is handled in units of a sector. Thus, as shown in FIG. 5, one file is divided into successive file data in units of a sector length SL in the host 900, and is transferred to the HDD 100 together with the write command. Specifically, when one file is to be stored in the HDD 100, the host 900 transfers, in the named order, file data Fd1 which is the start data of the file shown in FIG. 5, file data Fd2, file data Fd3, and file data Fd4 which is the end data of the file, as packets, to the HDD 100. For the purpose of convenience, one sector has been described as constituting the unit (one packet) of data transfer. However, a plurality of sectors may constitute the unit (packet) of data transfer between the host 900 and the HDD 100.

Next, a description is given of the file (file data) write process, the file read process and the processes associated with these processes, with use being made of the above-described HDD 100.

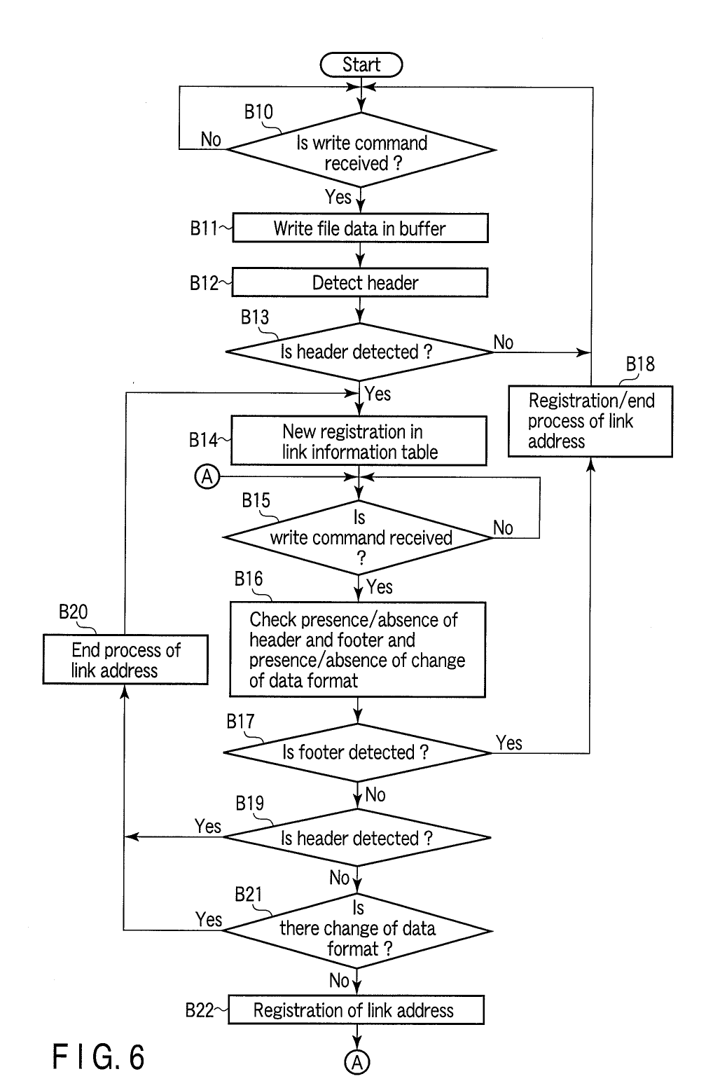

To begin with, the file (file data) write process and the link information creation process, which is executed at the time of writing the file (file data), are described with reference to a flow chart of FIG. 6. The process of FIG. 6 is executed by the controller 20.

To start with, if the input/output module 21 has received a write command from the host 900, the determination in block B10 in FIG. 6 is affirmed, and the process advances to block B11. Then, in block B11, the input/output module 21 writes file data, which is designated by the write command, in the buffer memory 40. Then, in block B12, the file start & end detection module 221 of the link information creation module 22 executes detection of the header in the file data that is designated by the write command. The detection of the header is executed by collating the file data which has been written in the buffer memory 40, and the header pattern of the file information table Ftbl in FIG. 3. In the following block B13, the file start & end detection module 221 determines whether the header pattern has been detected in block B12. If it is determined that the header pattern has been detected, the process advances to block B14. If it is determined that the header pattern has not been detected, the process returns to block B10 and transitions to a standby state to wait for a write command.

In block B14, the link information registration module 222 newly registers in the link information table Ltbl the link information (Li) having as start data the file data relating to the write command (the file data in which the header is present). Specifically, the link information registration module 222 registers the address (start address) on the magnetic disk 11, at which the start data is to be stored, and the data format of the file data in the link information table Ltbl shown in FIG. 2. At this time, it is assumed that the link address of the link information Li is still in an empty state (non-set state). In the case where link information Li having as start data the same data as the start data is already registered in the link information table Ltbl, this link information Li is updated.

Subsequently, in block B15, the input/output module 21 stands by until receiving the next write command. If the input/output module 21 receives the write command, the process advances to block B16 and the file start & end detection module 221 checks the presence/absence of the header and footer and the presence/absence of change of the data format. The detection of the presence/absence of the footer is performed based on the file information table Ftbl, like the above-described detection of the presence/absence of the header. The presence/absence of change of the data format is determined by discriminating the data format from the byte pattern of the file data, and comparing this data format with the data format of the link information Li registered in block B14. The agreement of the data formats means that there is no change of the data format and the file data is continuous, and the difference of the data formats means that there is a change of the data format and the file data is discontinuous.

In the next block B17, the file start & end detection module 221 determines whether the footer has been detected in the checking of block B16. If it is determined that the footer has been detected, the link information registration module 222 registers, in block B18, the address of the sector, in which the file data (end data) including the footer is recorded, at the link address of the link information Li which is being created. Then, the link information registration module 222 executes the registration end process of the link information which is being created. The registration end process is a process of adding a terminal code [end] to the end of the link address. If the process of block B18 is completed, the process returns to block B10 and transitions to the standby state to wait for a write command.

On the other hand, if it is determined in block B17 that the footer has not been detected, the process advances to block B19. In block B19, the file start & end detection module 221 determines whether the header has been detected in the checking of block B16. If it is determined that the header has been detected, the link information registration module 222 executes, in block B20, the process of finishing the creation of the link information Li which is currently being created (i.e. the process of adding the terminal code [end]), and the process returns to block B14. In block B14, new link information Li is registered based on the write command which has already been received in block B15, and the creation of the new link information Li is started. On the other hand, if it is determined in block B19 that the header has not been detected, the process advances to block B21.

In block B21, the file start & end detection module 221 determines whether there has been a change in the data format in the checking of block B16. If it is determined that there has been a change in the data format, the link information registration module 222, like the case of the affirmative determination in block B19, executes in block B20 the process of finishing the creation of the link information Li which is being created (i.e. the process of adding the terminal code [end]), and the process returns to block B14. In block B14, new link information Li is registered based on the write command which has been received in block B15, and the creation of the new link information Li is started. On the other hand, if it is determined in block B21 that there has not been a change in the data format, the process advances to block B22.

In block B22, the link information registration module 222 registers, in the link information Li that is being created, the link address relating to the write command that has been received in block B15. After the completion of registration, the process advances to block B15. Thereafter, the same process as the above-described process beginning with block B15 is executed, and the registration of the link information Li in the link information table is continuously executed.

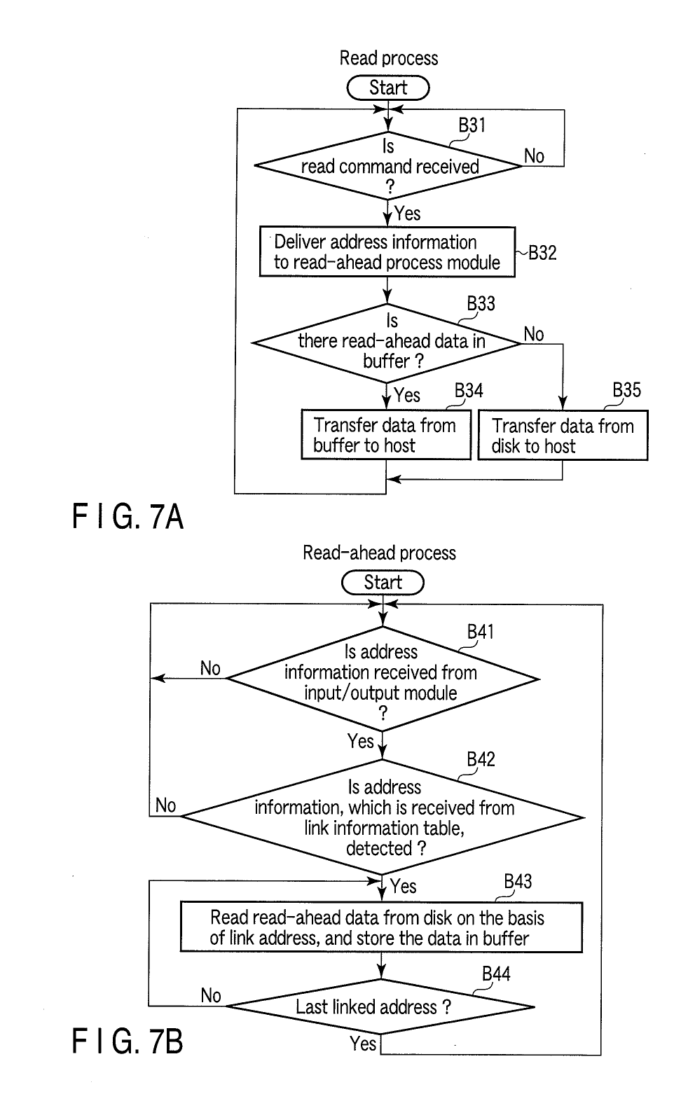

Next, referring to flow charts of FIG. 7A and FIG. 7B, a description is given of the method of reading out a file (file data) with use of the link information table which is created as described above. FIG. 7A illustrates a read process which is executed by the input/output module 21 shown in FIG. 4, and FIG. 7B illustrates a read-ahead process which is executed by the read-ahead module 23 shown in FIG. 4. The processes of FIG. 7A and FIG. 7B are executed in parallel.

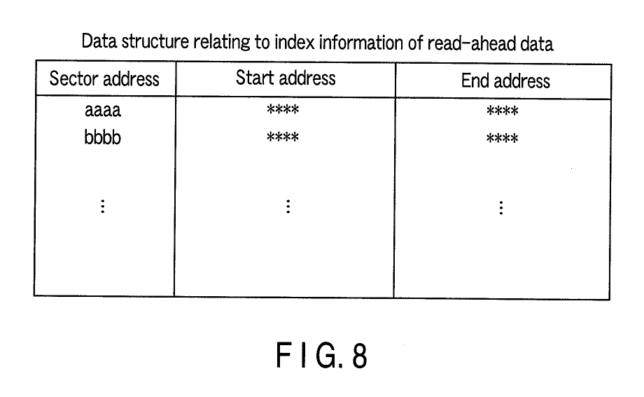

To start with, if the input/output module 21 receives a read command from the host 900, the determination in block B31 in FIG. 7A is affirmed, and the process advances to block B32. In block B32, address information included in the read command is delivered to the read-ahead process module 23. Then, in block B33, the input/output module 21 determines whether the file data, which is recorded at the address of the sector designated by the read command, is already present in the buffer memory 40, that is, whether the read-ahead of the file data has already been executed. The index information of the read-ahead data stored in the buffer memory 40 has a data structure as shown in FIG. 8. As is understood from FIG. 8, the index information of read-ahead data includes an address of a sector, and a start address and an end address in the buffer memory 40 at which the file data recorded in the sector is stored. Thus, the determination in block B33 is executed on the basis of whether an address agreeing with the address designated by the read command is present in the field of the sector address.

If it is determined in block B33 that the file data of the sector designated by the read command is present in the buffer memory 40, the input/output module 21, in block B34, transfers this data from the buffer memory 40 to the host 900. On the other hand, if it is determined in block B33 that the file data of the sector designated by the read command is not present in the buffer memory 40, the input/output module 21, in block B35, reads this data from the magnetic disk 11 and transfers the read data to the host 900. Thereafter, the process returns to block B31, and the input/output module 21 repeats the determination processes of blocks B32, B33 and B34 (or B35) each time the read command is received.

On the other hand, in block B41 in FIG. 7B, the read-ahead process module 23 stands by until receiving address information from the input/output module 21. The process advances to block B42 at a time when the process by the input/output module 21 has been executed in block B32 in FIG. 7A and the address information from the input/output module 21 has been received.

Then, in block B42, the read-ahead process module 23 refers to the link information table Ltbl and determines whether the address information received in block B41 is included in the link information table Ltbl. If the received address information is not included in the link information table Ltbl, there is no data which is to be read ahead by the read-ahead process module 23. Thus, the read-ahead process module 23 returns to block B41 and stands by to wait for address information. On the other hand, if the received address information is included in the link information table Ltbl, the process advances to block B43. In this case, since there is data that needs to be read ahead by the read-ahead process module 23, the read-ahead process module 23 performs, in block B43, a read-ahead of the data by accessing the magnetic disk 11 on the basis of the link information (link address) of the link information table Ltbl, and stores the data in the buffer memory 40.

Subsequently, in block B44, the read-ahead process module 23 determines whether the address of the read-ahead data is the last address, on the basis of the link information table Ltbl. In this case, the read-ahead process module 23 refers to the field of the link address in the link information table Ltbl, and determines whether the address of the read-ahead data is the last address, according to whether the terminal code [end] is added to the address of the read-ahead data. If it is determined that the address of the read-ahead data is not the last address, there still remains data that is to be read ahead, and the process returns to block B43 to execute a read-ahead of the next data. When the determination in block B44 is affirmed, the process returns to block B41 and transitions to the standby state to wait for new address information.

In the present embodiment, the above-described process is repeated. When the read command relating to the file data of the start address is received, the read-ahead process module 23 performs a read-ahead of the respective data of respective addresses which are linked to the start address, and stores the read-ahead data in the buffer memory 40. When the controller 20 receives the next read command, the read-ahead file data is directly transferred from the buffer memory 40 to the host 900.

As has been described above in detail, according to the present embodiment, when plural data included in a single file are dividedly written in plural sectors of the magnetic disk 11, the link information creation module 22 associates the plural sectors (i.e. creates link information) in the order according to the continuity of data (file data) of the single file. When a data read request (read command) is received, the read-ahead process module 23 performs a read-ahead of data on the basis of the link information. It is thus possible to read out in advance the data, the read command of which is expected to be next output from the host, and to store the data in the buffer memory 40. The time that is needed for data transfer between the buffer memory 40 and the host 900 is much shorter than the time that is needed for direct data read from the magnetic disk 11 and transfer to the host 900. Accordingly, the time that is needed for data read of the HDD 100 can remarkably be decreased by performing a data read-ahead process while waiting for a read command and by transferring the data from the buffer memory 40 to the host 900 at a time when the read command has been received. In this case, since the read-ahead is executed on the basis of the link information which is created when data is recorded in the magnetic disk 11, the data read speed can be increased regardless of the data access method, without deteriorating the general-purpose applicability of the magnetic disk 11.

In the read-ahead process of the embodiment, the link information is created when data is recorded, and the read-ahead process is executed on the basis of the link information. Therefore, the read-ahead process is preferably applicable to the storage device which adopts a recording method in which successive data are randomly recorded in plural sectors on the magnetic disk 11, that is, a so-called random-access method. There is conventionally known a cache memory technique in which data of sectors in a range, which physically neighbors a sector designated by a read command, is read out to a buffer in advance. It is thinkable to apply this cache memory technique to the random access method. However, if this cache memory technique is applied to the random access method, it is necessary to perform a read-ahead of data in a very wide range in which successive data are assumed to be present. This may lead to an increase in storage capacity of the cache memory and an increase in time for data read from the cache memory. As regards this point, if the read-ahead process of the present embodiment is adopted, it is possible to perform a read-ahead of successive data, which belong to the same file as the data that is the object of the read request, in a pinpoint reading manner. Therefore, it is possible to realize the reduction in storage capacity necessary for the cache memory, and the decrease in time for data read from the cache memory.

In the conventional cache memory technique, for example, in the case where read of data of a cache memory becomes necessary immediately after the data is discarded, it is necessary to perform a read-ahead of the data once again, which is inefficient. In the method of the embodiment, since necessary data is expected and this data is read ahead, the possibility of performing read-ahead once again can be decreased.

The above-described embodiment is directed to the case where the read-ahead process is executed with respect to a file which is registered in the link information table Ltbl, and the read-ahead process is not executed with respect to a file which is not registered. However, the invention is not limited to this case. For example, the invention is applicable to the case where the read-ahead process is executed with respect to a file which is registered in the link information table Ltbl, and the above-described cache memory technique is applied when a read command relating to a file which is not registered is received.

The above-described embodiment is directed to the case where a predetermined storage region on the magnetic disk 11 is used as a storage region for temporarily storing data, which is stored in the control memory 30, when the HDD 100 is powered off. The invention, however, is not limited to this case. A nonvolatile memory, such as a flash memory, may be provided in the HDD 100, and this nonvolatile memory may be used for temporary data storage. In addition, a nonvolatile memory may be adopted as the buffer memory 40.

The data structures of the link information Li (FIG. 2) and file information Fi (FIG. 3), which are shown in the embodiment, are merely examples. According to purposes of use, various modifications may be made. For example, in the above-described embodiment, the start position and end position of a file are detected on the basis of the header information and footer information of the file information table Ftbl and the information of the data format of the link information table Ltbl. However, the start and end of the file can be detected on the basis of at least one of the header information, the footer information and the information of the data format. Accordingly, at least one of these information items may be stored in a table form in the control memory 30. Besides, an index, other than the header information, footer information and data format, may be adopted in a table form.

The above-described embodiment is directed to the case where the HDD using the magnetic disk is adopted as the storage device. The invention, however, is not limited to this case. As the storage device, use may be made of optical disc devices, such as CD (Compact Disc) or DVD (Digital Versatile Disk) devices, or other storage devices.

The above-described embodiment is directed to the case where the host 900 is a personal computer. The invention, however, is not limited to this case. For example, a work station, such as a Web server or a mail server, may be adopted as the host.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a storage medium comprising a plurality of storage regions configured to store a plurality of data in a single file;
a link information creation module configured to create one or more link information associating the plurality of storage regions according to a continuity of the plurality of data; and
a read-ahead module configured to read-ahead of data stored in a storage region according to the one or more link information when a data read request is received from a host, the storage region being associated with a second storage region on the storage medium designated by the data read request.

2. The storage device of claim 1, wherein the plurality of storage regions which store the plurality of data are randomly disposed on the storage medium.

3. The storage device of claim 1, wherein the link information creation module is configured to create the one or more link information of the file when a start data of the file is detected.

4. The storage device of claim 2, wherein the link information creation module is configured to create the one or more link information of the file when a start data of the file is detected.

5. The storage device of claim 3, wherein the start data comprises a header.

6. The storage device of claim 4, wherein the start data comprises a header.

7. A method of controlling write and read operations in a storage device, comprising:
writing a plurality of data in a single file on a plurality of storage regions on a storage medium;
creating one or more link information for associating the plurality of storage regions on the storage medium, which store the plurality of data in the file according to a continuity of the plurality of data; and
performing a read-ahead of data stored in a storage region on the basis of the one or more link information according to an external data read request, the storage region being associated with a second storage region of the storage medium designated by the data read request.
